(19) United States
(12) Patent Application Publication
(10) Pub. No.: US 2008/0043907 A1
(43) Pub. Date: Feb. 21, 2008

(54) METHOD FOR MEASURING THE WALL THICKNESS OF A PLASTIC SHEATHING FOR AN ELECTRICAL CORE OR CABLE, IN PARTICULAR A POWER CABLE

(75) Inventor: Harald Sikora, Bremen (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Sikora AG, Bremen (DE)

(21) Appl. No.: 11/840,522

(22) Filed: Aug. 17, 2007

(30) Foreign Application Priority Data
Aug. 19, 2006 (DE) 10 2006 039 031.8

(51) Int. Cl. G01B 21/02; G01N 23/083

(52) U.S. Cl. 378/54

(57) ABSTRACT

A method for measuring the wall thickness of a plastic sheathing of an electrical core or cable, in particular a power cable having at least one core, wherein the absorption capacity of the material surrounding the plastic sheathing approximates or is similar to that of the plastic sheathing, wherein the core or the cable is irradiated at a right angle to its extension on one side by x-ray radiation and the wall thickness of the encased core or cable is determined on the opposite side from the distribution of the intensity of the detected x-ray, characterized in that the material of the plastic sheathing or a plastic material surrounding the plastic sheathing is foamed prior to measuring the wall thickness for the purpose of modifying its absorption capacity.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The usual design of power cables has a plurality of conductor strands surrounded by a sheathing made of plastic. The sheathing can serve to insulate and also to provide mechanical protection. For their part, the individual conductors are surrounded by an insulating layer and are identified here as cores. Regardless of whether the cores exhibit a round or sector shape in cross-section, interstices and gaps occur between the outside of the cores and the inside of the sheathing which is desirously circular in cross-section. It is known to fill these gaps with a filler material which additionally serves to achieve the circular shape to the sheathing during extrusion.

For reasons of cost, the filler material is usually of inferior plastic such as, for example, recycled PVC. The sheathing, however, which is likewise frequently made from PVC, is of higher quality in order to achieve the desired insulating, respectively protective properties. Using PE or EPR material is also known.

For reasons of cost, it is endeavored to configure the wall thickness of the sheathing so as to be no thicker than necessary. Wall thickness is predetermined by the desired insulating or protectability to be afforded the sheathing or by general regulations. Extra wall thickness to the sheathing leads to an unnecessary increase in material use, In light of the above, it has long since been known to measure the wall thickness of the sheathing of such cables in order to control the extrusion of the sheathing pursuant measured values.

X-ray irradiation is a commonly-used method for measuring the wall thickness of plastic sheathing. Yet this method is not always satisfactory with respect to the known cables at issue because the contrast between the plastic of the sheathing and the material, e.g. filler, material, surrounding the sheathing is too low. The contrast is particularly low when the filler material is made of the same, even if inferior, plastic as the sheathing.

A similar problem arises with the cores of a cable; i.e. encased conductors of, for example, aluminum. The absorption capacity of aluminum with respect to x-rays resembles that of e.g. PVC. Using X-ray measurements to determine the wall thickness of the sheathing does not lead to satisfactory results.

Therefore, the object on which the invention is based is that of specifying a method applicable to plastic-encased cores and cables which improves the contrast between the sheathing and the surrounding material when using x-ray technology to measure the wall thickness of the sheathing.

### BRIEF SUMMARY OF THE INVENTION

To attain sufficient contrast according to the inventive method, the plastic sheathing of a core or plastic material surrounding the plastic sheathing is foamed. The foaming of the plastic preferably ensues during extrusion using a gas, e.g. nitrogen. A chemical foaming is also alternatively feasible.

Foaming of plastic is known per se, e.g. a physical gas-based process. Also known is foaming the insulating sheath of high-frequency cables. The purpose of this measure is to reduce the relative electric constant so as to improve transmission capacity. With the invention, however, the foaming of the plastic material serves to increase the contrast to the plastic of the sheathing or the conductor. The invention therefore helps to facilitate measuring the wall thickness of cable sheathing, in particular power cables. Inaccurate measurements are thus avoided, and hence also undesirable undercutting or exceeding of the desired wall thickness.

The invention moreover has the advantage of reducing material use. Foaming reduces the amount of material used per volume unit.

The following will draw on an exemplary embodiment in describing the invention in greater detail.

### BRIEF DESCRIPTION OF THE DRAWING

FIG. 1 shows a sectional cut through a power cable.

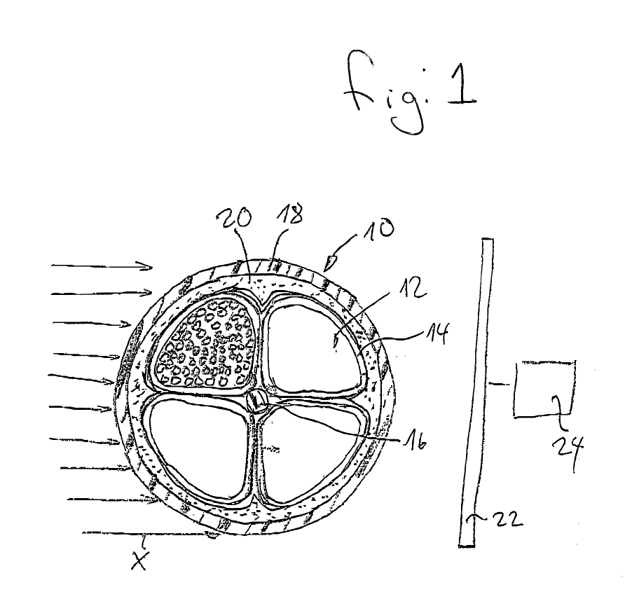

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

The cable 10 according to the figure exhibits four sector-shaped cores 12 which are surrounded by an insulating layer 14, The figure only shows one core with individual conductors in section. A plastic circular strand 16 in section is inserted in the interstice between the cores 12. The cores 12 are surrounded by a common plastic sheathing 18 which is circular in section and can consist of a plurality of layers. A filler material 20 is provided between the sheathing 18 and the cores 12. The filler material consists of, for example, recycled PVC while the sheathing 18 consists of pure PVC. The filler material 20 is foamed. The foaming occurs preferably during extrusion either physically or chemically. In the extrusion, the bundle of cores 12 with their sheathing 14 are advanced through the extruder and successively coated with the filler material and the sheathing 18 in a co-extrusion process. In the extruding of the filler material 20, a sufficient amount of e.g. gas is supplied, whereby a foaming of the filler material 20 occurs.

When measuring the wall thickness of the sheathing 18, the cable 10 is irradiated at a right angle by an x-ray source, as indicated by X. An x-ray detector 22, e.g. a line sensor, is arranged on the opposite side to measure the distribution of the impinging intensity of the x-ray. It is to be understood that the sheathing 18, the cores 12 and also the filler material 20 absorb x-ray radiation differently. This variance is used to determine the wall thickness to the sheathing 18 since same is of importance to the manufacturing process. Because the filler material 20 is foamed, the x-ray absorption is clearly reduced, even when the filler material 20 is chemically identical to the material of the sheathing 18.

The x-ray detector 22 is connected to a measuring device 24 which determines the wall thickness of the sheathing from the signals coming from the detector 22 and forwards same to e.g. a control device for a not shown extruder.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What we claim is:

1. A method for measuring the wall thickness of a plastic sheathing of an electrical core or cable, in particular a power cable having at least one core, wherein the absorption capacity of the material surrounding the plastic sheathing approximates or is similar to that of the plastic sheathing, wherein the core or the cable is irradiated at a right angle to its extension on one side by x-ray radiation and the wall thickness of the encased core or cable is determined on the opposite side from the distribution of the intensity of the detected x-ray, characterized in that the material of the plastic sheathing or a plastic material surrounding the plastic sheathing is foamed prior to measuring the wall thickness for the purpose of modifying its absorption capacity.

2. The method according to claim 1, characterized in that the plastic material is foamed physically using a gas, in particular nitrogen, or chemically.

3. The method according to claim 1, characterized in that a filler material in a cable is foamed between the cable sheathing and the sheathed cores.

4. The method according to claim 1, characterized in that an insulating plastic sheathing is foamed around a core having an aluminum conductor.

5. An electrical core or electrical cable having a sheathing made of plastic, wherein the material surrounding the sheathing exhibits an absorption capacity approximate or similar to the plastic sheathing, characterized in that the plastic sheathing or a material surrounding the plastic sheathing on the inside of the sheathing is foamed plastic.

6. A core or cable according to claim 5, characterized in that the foamed plastic is a filler material between the outer plastic sheathing and the encased cores within the plastic sheathing.

7. A core or cable according to claim 5, characterized in that the plastic sheathing of a core with aluminum conductor is foamed.

8. A core or cable according to claim 5, characterized in that the foamed plastic material is recycled plastic.

9. A core or cable according to claim 5, characterized in that PVC, PE or EPR is provided as the foamed plastic.
